(19) United States
(12) Patent Application Publication
(10) Pub. No.: US 2009/0168425 A1
(43) Pub. Date: Jul. 2, 2009

(54) BULB WITH ROTATING LIGHT EFFECT

(76) Inventor: Ming-Chih Chuang, Taipei Hsien (TW)

Correspondence Address: Ming-Chih Chuang, 235 Chung - Ho, Box 8-24, Taipei, R. O. C., TW

(21) Appl. No.: 11/967,253

(22) Filed: Dec. 30, 2007

(51) Int. Cl. F21V 17/02

(52) U.S. Cl. 362/284

(57) ABSTRACT

A bulb with rotating light effect comprises a bulb casing being a hollow casing; an inner lower side of the bulb casing being formed with an engaging portion; the engaging portion having a plurality of teeth for engaging with other elements; a seat having a receiving space for receiving other elements; a top end of the seat having a connecting portion; a motor installed in the receiving space of the seat for driving other elements; a gear connected to a spindle of the motor; the gear being an axial gear which is engaged on the spindle of the motor; rotation of the motor will drive the gear to rotate; the gear being engaged to the teeth of the engaging portion; thus, when the gear rotates, the bulb casing is driven to rotate; and an LED lamp set having at least one LED.

### FIELD OF THE INVENTION

The present invention relates to bulbs, and particularly to a bulb with rotating light effect and patterns so as to present different light effects in different directions. The bulb casing is changeable as desired so as to have various patterns according to acquirement of the users.

### BACKGROUND OF THE INVENTION

In the prior art bulb, the bulb has a seat, a bulb casing installed upon the bulb, and a light emitting element in installed upon the seat and within the bulb casing. In the prior art, the light emitting element is general tungsten silks which can emit light. However currently under the consideration of environment protection and power saving, LEDs (light emitting diodes) have become a trend as the light emitting element of the bulb, because it can emit light with an efficiency higher than that of the conventional bulb, but emit very little heat so as to have the effect of environment protection.

Moreover, the conventional bulb is a dull appearance, which emits light without any variation, light emitted from the bulb is identical in any direction. It can not present different light effect so as not to present different feeling to the users. In summary, the conventional bulb has only the effect of light emitting.

### SUMMARY OF THE INVENTION

Accordingly, the object of the present invention is to provide a bulb with rotating light effect and patterns so as to present different light effect in different directions. The bulb casing is changeable as desired so as to have various patterns according to acquirement of the users.

To achieve above object, the present invention provides a bulb with rotating light effect comprises a bulb casing being a hollow casing; an inner lower side of the bulb casing being formed with an engaging portion; the engaging portion having a plurality of teeth for engaging with other elements; a seat having a receiving space for receiving other elements; a top end of the seat having a connecting portion; a motor installed in the receiving space of the seat for driving other elements; a gear connected to a spindle of the motor; the gear being an axial gear which is engaged on the spindle of the motor; rotation of the motor will drive the gear to rotate; the gear being engaged to the teeth of the engaging portion; thus, when the gear rotates, the bulb casing is driven to rotate; and an LED lamp set having at least one LED.

Furthermore, the present invention further provides a bulb with rotating light effect comprising: a bulb casing being a hollow casing; a seat having a receiving space for receiving other elements; a top end of the seat having a connecting portion; a motor installed in the receiving space of the seat for driving other elements; a gear connected to a spindle of the motor; the gear being an axial gear which is engaged on the spindle of the motor; rotation of the motor will drive the gear to rotate; and an LED lamp set having at least one LED; LED lamp set having a combining portion which a plurality of teeth at a periphery thereof; the teeth of the combining portion being engaged to the gear so that rotation of the motor will drive the LED lamp set to rotate.

The various objects and advantages of the present invention will be more readily understood from the following detailed description when read in conjunction with the appended drawing.

### BRIEF DESCRIPTION OF THE DRAWINGS

FIG. 1(A) is a perspective view of the bulb casing of the present invention.

FIG. 1(B) is a cross sectional view of the bulb casing of the present invention.

FIG. 2 is a perspective view of the seat of the present invention.

FIG. 3 is a schematic view showing the gear and motor of the present invention.

FIG. 4 is a perspective view showing the remote control device of the present invention.

FIG. 5 is a schematic cross sectional view showing the rotation of the bulb casing according to the present invention.

FIG. 6(A) shows an example about the pattern on the bulb casing of the present invention.

FIG. 6(B) shows another example about the pattern of the bulb casing of the present invention.

FIG. 7 shows a perspective view about the bulb casing in the second embodiment of the present invention.

FIG. 8 is a perspective view about the seat in the second embodiment of the present invention.

FIG. 9 is a schematic cross sectional view of the second embodiment of the present invention showing the rotation of the LED lamp set according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

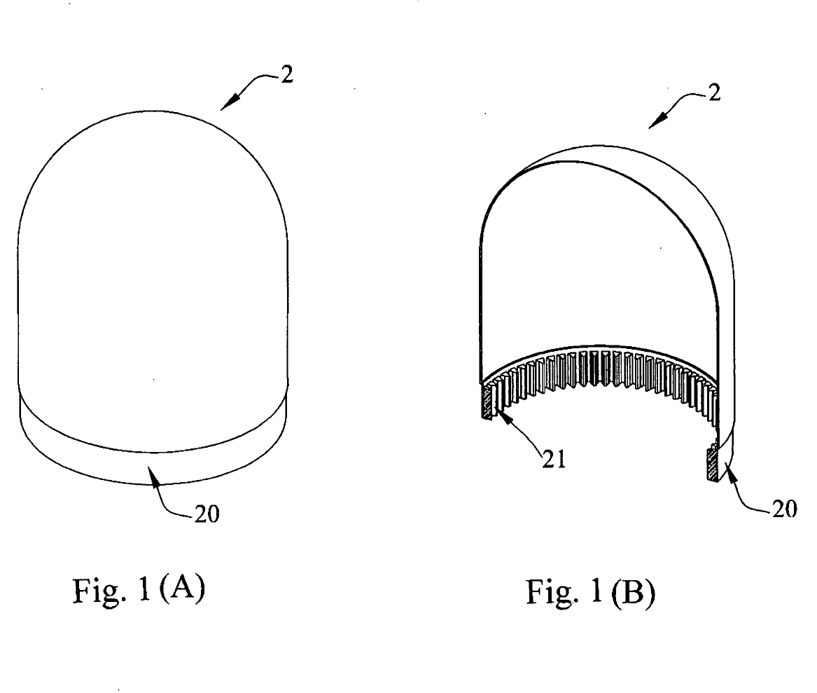

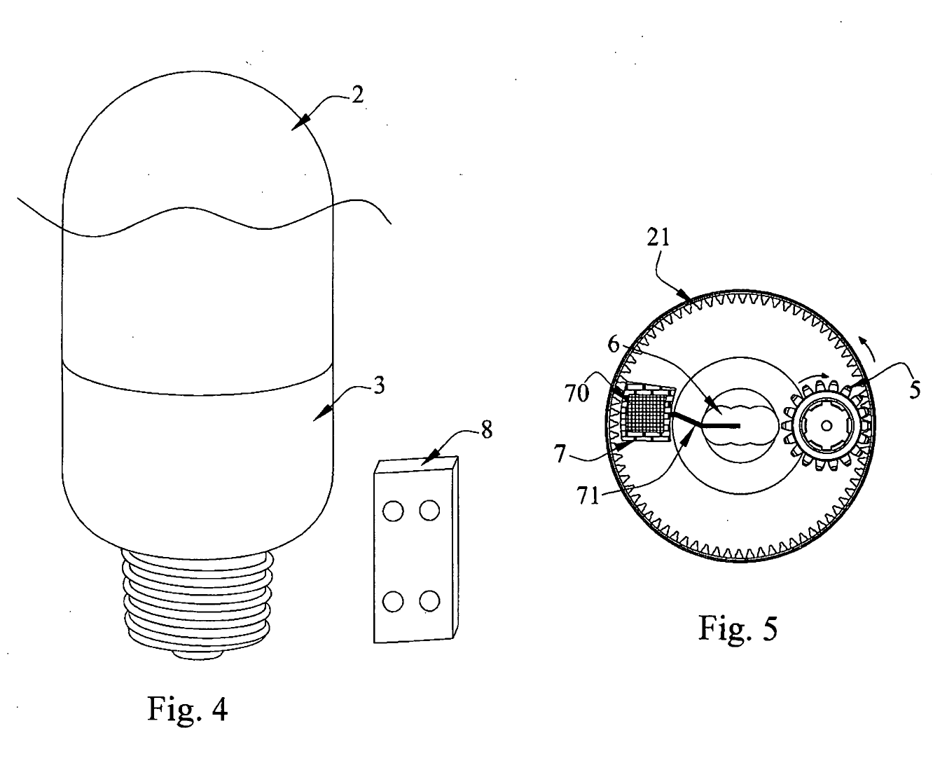

Referring to FIGS. 1 to 6, the first embodiment of the present invention is illustrated. The bulb of the present invention has the following elements.

A bulb casing 2 is a hollow casing. Light can pass through the bulb casing 2. An inner lower side of the bulb casing 2 is formed with an engaging portion 20. The engaging portion 20 has a plurality of teeth 21 for engaging with other elements (referring to FIG. 1(A) and FIG. 1(b).

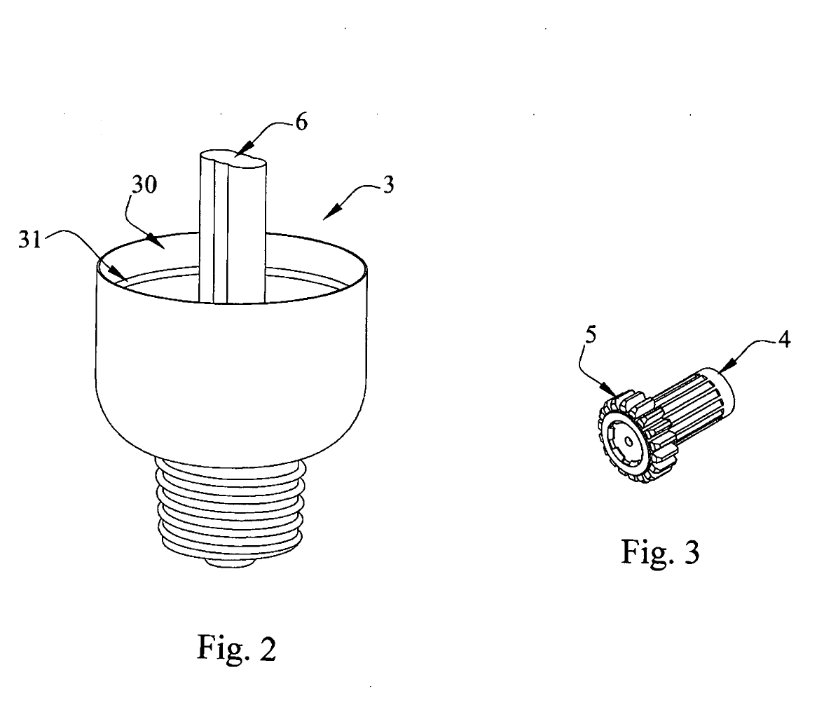

A seat 3 has a receiving space for receiving other elements. A top end of the seat 3 has a connecting portion 30. A lower side of the connecting portion 30 has a flange 31 so that the connecting portion 30 can be engaged to the bulb casing to fixed thereto (referring to FIG. 2).

Referring to FIGS. 3 to 5, a plurality of elements are received in the receiving space of the seat 3.

A motor 4 is installed in the receiving space of the seat 3 for driving other elements.

A gear 5 is connected to a spindle of the motor 4. The gear 5 may be an axial gear which is engaged on the spindle of the motor 4. Rotation of the motor 4 will drive the gear 5 to rotate. The gear 5 is engaged to the teeth 21 of the engaging portion 20. Thus, when the gear 5 rotates, the bulb casing 2 is driven to rotate.

An LED lamp set 6 has at least one LED. When the LED lamp set 6 has plurality of LEDs, the LEDs may emit light beams of different colors.

A control circuit board 7 is connected to one end of a wire 71. Another end of the wire 71 is connected to the LED lamp set 6 for controlling the LED lamp set 6. The control circuit board 7 may include a transceiver 70 for transmitting and receiving signals remotely.

In the present invention, the motor 4 is connected to the control circuit board 7 or the motor 4 is connected to a power source. In the former case, the control circuit board 7 will control the rotation of the motor 4.

A remote controller 8 serves for remotely controlling the control circuit board 7 through the transceiver 70 of the control circuit board 7 so as to control the LED lamp set 6 or the motor 4 remotely.

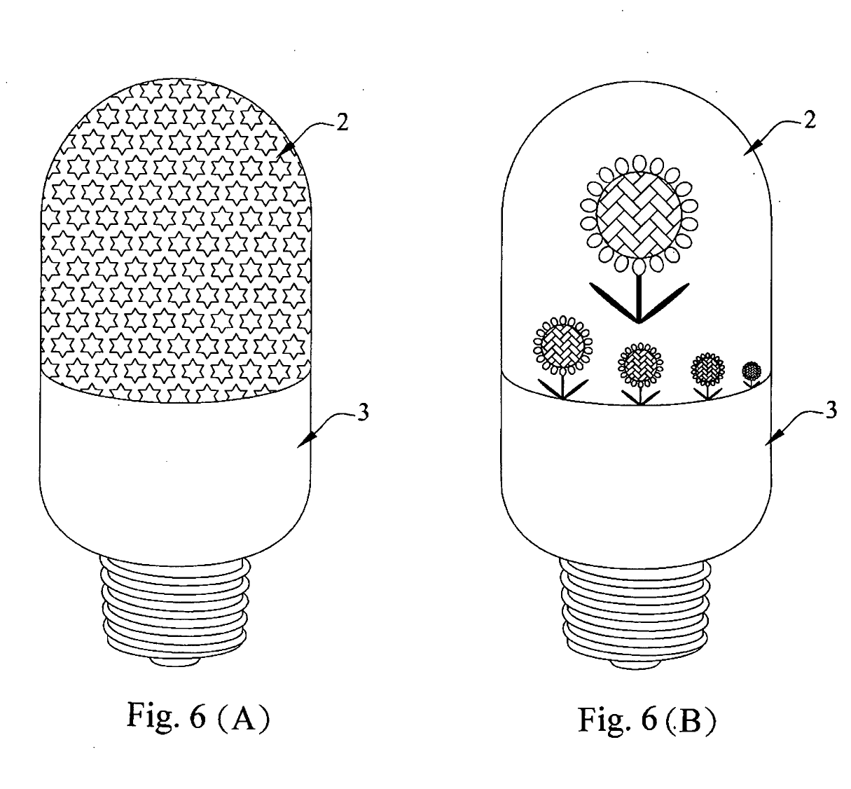

Referring to FIGS. 6(A) and 6(B), in the present invention, the bulb casing 2 may have different patterns for presenting different projection effects.

In the present invention, when the power is turned on, the motor 4 rotates and the bulb casing 2 is driven to rotate so as to present different light effect.

It should be noted that in the present invention, the bulb casing 2 is changeable so that a plurality of patterns can be presented as desired.

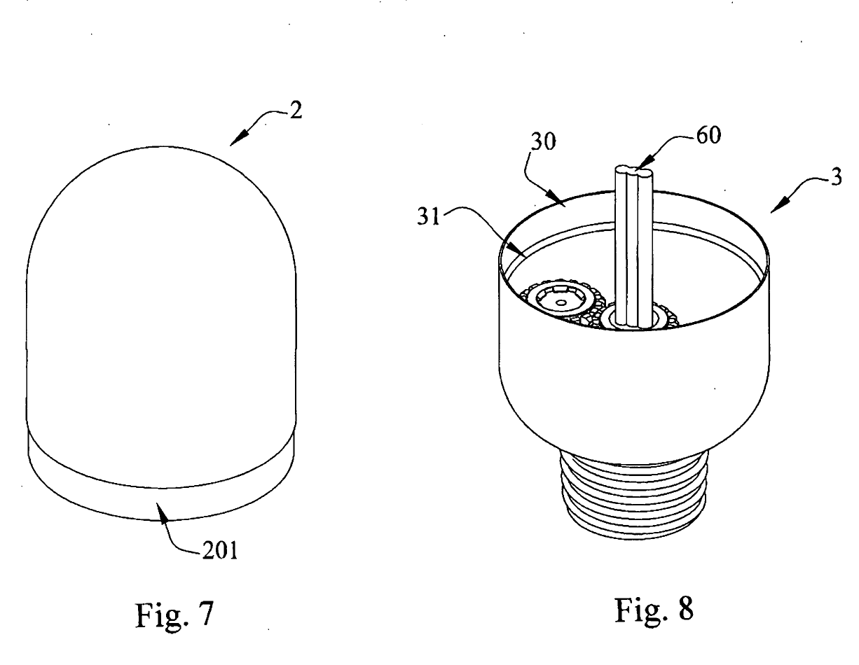

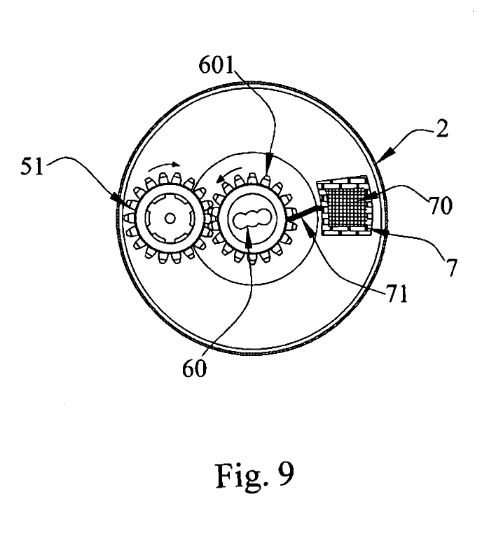

Referring to FIGS. 7 to 9, the second embodiment of the present invention is illustrated. In this embodiment, those identical to the above embodiment will not be further described herein. Only those different from above embodiment are described.

In the present invention, the LED lamp set 6 is rotatable. The embodiment has the following elements.

A bulb casing 2 is a hollow casing. Light can pass through the bulb casing 2. A lower side of the bulb casing 2 is reduced inwards as a combining portion 201 for connecting other elements (referring to FIG. 7).

The bulb casing 2 has different patterns thereon.

A seat 3 has a receiving space for receiving other elements. A top of the seat 3 has a connecting portion 301. A lower end of the connecting portion 30 has a flange 31 for combining the combining portion 201 (referring to FIG. 8).

A LED lamp set 6 has a plurality of teeth 601 at a periphery thereof for engaging a gear. The LED lamp set 6 has at least one LED. When the LED lamp set 6 has plurality of LEDs, the LEDs may emit light beams of different colors.

A motor 40 is installed in the receiving space of the seat 3 for driving other elements.

A gear 50 is connected to a spindle of the motor 40. The gear 50 may be an axial gear which is engaged on the spindle of the motor 40. Rotation of the motor 40 will drive the gear 5 to rotate. The gear 5 is engaged to the teeth 601 of the LED lamp set 6. Thus, when the gear 50 rotates, the LED lamp set 6 is driven to rotate.

An LED lamp set 60 has at least one LED. When the LED lamp set 6 has plurality of LEDs, the LEDs may emit light beams of different colors.

A control circuit board 7 is connected to one end of a wire 71. Another end of the wire 71 is connected to the LED lamp set 60 for controlling the LED lamp set 60. The control circuit board 7 may include a transceiver 70 for transmitting and receiving signals remotely.

In the present invention, the motor 40 is connected to the control circuit board 7 or the motor 40 is connected to a power source. In the former case, the control circuit board 7 will control the rotation of the motor 40.

A remote controller 8 serves for remotely controlling the control circuit board 7 through the transceiver 70 of the control circuit board 7 so as to control the LED lamp set 60 or the motor 40 remotely.

In the present invention, when the power source is turned on, the motor 40 rotates to drive the LED lamp set 60 to rotate. The light from the LED lamp set 60 projects to the bulb casing 2 so as to present different light effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bulb with rotating light effect comprising:
a bulb casing being a hollow casing; light can passes through the bulb casing; a lower side of the bulb casing being formed with an engaging portion; the engaging portion having a plurality of teeth for engaging with other elements;
a seat having a receiving space for receiving other elements; a top end of the seat having a connecting portion;
a motor installed in the receiving space of the seat for driving other elements;
a gear connected to a spindle of the motor; the gear being engaged on the spindle of the motor; rotation of the motor will drive the gear to rotate; the gear being engaged to the teeth of the engaging portion; thus, when the gear rotates, the bulb casing is driven to rotate; and
an LED lamp set having at least one LED.

2. The bulb with rotating light effect as claimed in claim 1, further comprising:
a control circuit board connected to the LED lamp set for controlling the LED lamp set.

3. The bulb with rotating light effect as claimed in claim 2, further comprising:
a transceiver in the control circuit board for transmitting and receiving signals remotely; and
a remote controller for remotely controlling the control circuit board through the transceiver of the control circuit board so as to control the LED lamp set or the motor remotely.

4. The bulb with rotating light effect as claimed in claim 1, wherein the motor is connected to the control circuit board to be controlled by the control circuit board.

5. The bulb with rotating light effect as claimed in claim 1, wherein the bulb casing is changeable.

6. The bulb with rotating light effect as claimed in claim 1, wherein a lower side of the connecting portion having a flange for engaging with the bulb seat.

7. The bulb with rotating light effect as claimed in claim 1, wherein the LED lamp set has a plurality of LEDs and the LEDs emit light beams of different colors.

8. A bulb with rotating light effect comprising:
a bulb casing being a hollow casing; light can pass through the bulb casing;
a seat having a receiving space for receiving other elements; a top end of the seat having a connecting portion;
a motor installed in the receiving space of the seat for driving other elements;
a gear connected to a spindle of the motor; the gear being an axial gear which is engaged on the spindle of the motor; rotation of the motor will drive the gear to rotate; and
an LED lamp set having at least one LED; LED lamp set having a combining portion which a plurality of teeth at a periphery thereof; the teeth of the combining portion being engaged to the gear so that rotation of the motor will drive the LED lamp set to rotate.

9. The bulb with rotating light effect as claimed in claim 8, further comprising:
a control circuit board connected to the LED lamp set for controlling the LED lamp set.

10. The bulb with rotating light effect as claimed in claim 9, further comprising:
a transceiver in the control circuit board for transmitting and receiving signals remotely; and
a remote controller for remotely controlling the control circuit board through the transceiver of the control circuit board so as to control the LED lamp set or the motor remotely.

11. The bulb with rotating light effect as claimed in claim 8, wherein the motor is connected to the control circuit board to be controlled by the control circuit board.

12. The bulb with rotating light effect as claimed in claim 8, wherein the bulb casing is updatable.

13. The bulb with rotating light effect as claimed in claim 8, wherein the connecting portion having a flange for engaging with the seat.

14. The bulb with rotating light effect as claimed in claim 1, wherein the LED lamp set has a plurality of LEDs and the LEDs emit light beams of different colors.
